(19) United States
(12) Patent Application Publication
(10) Pub. No.: US 2021/0092677 A1
(43) Pub. Date: Mar. 25, 2021

(54) Radio Access Technology Selection in Multimode Internet of Things Devices

(71) Applicant: QUALCOMM Incorporated, San Diego, CA (US)

(72) Inventors: Jayesh BATHIJA, San Diego, CA (US); Liangchi HSU, San Diego, CA (US); Raghavendra Shyam ANANDA, Hyderabad (IN); Srikanth MENON, Hyderabad (IN); Kirankumar Bhoja ANCHAN, San Diego, CA (US)

(21) Appl. No.: 16/580,321

(22) Filed: Sep. 24, 2019

(51) Int. Cl. H04W 52/02

(52) U.S. Cl. CPC H04W 52/0216; H04W 88/06; H04W 52/0254; H04W 52/0229

(57) ABSTRACT

Methods for conserving power in a multi-mode wireless device capable of communicating via a first radio access technology (RAT) and second RAT in which communication using the first RAT is preferred are disclosed. Various embodiments may include methods to determine whether a condition warrants attempting a connection with the first RAT in response to the multi-mode wireless device communicating using the second RAT, in response to determining that no condition warrants attempting a wireless connection using the first RAT, continue to communicate using the second RAT for a first duration before again determining whether a condition warrants attempting a connection with the first RAT, and determine whether a connection can be made to the first preferred RAT in response to determining that a condition warrants attempting a wireless connection using the first RAT.

### BACKGROUND

Long Term Evolution (LTE), 5G new radio (NR), and other recently developed communication technologies have broadened the availability and scale of wireless communications, supporting the development of new types of wireless devices and services unavailable just a few years ago. Advancements in wireless communication technologies have resulted in the development of a wide variety of wireless devices known collectively as the Internet of things (IoT) devices. IoT devices encompass a wide range of applications, from appliances, to sensors, to monitoring and industrial equipment that heretofore have not been connected to a network. Recently, wireless communications standards bodies have approved two long-term evolution (LTE) based wireless communication protocols, referred to as radio access technologies (RAT), to support communications with IoT devices, namely LTE Category M (Cat. M), and Narrowband-IoT (NB-IoT). These alternative RATs support communications between IoT devices and a base station. These two IoT communication protocols are designed to minimize the power consumption by IoT devices, leveraging the fact that such devices typically have minimal bandwidth requirements. As a result, some IoT devices that are battery-powered are expected to have battery endurance up to 30 years.

### SUMMARY

Various aspects include methods for conserving power in a multi-mode wireless device capable of communicating via a first radio access technology (RAT) and second RAT in which communication using the first RAT is preferred.

One aspect of the present disclosure relates to a method for conserving power in a multi-mode wireless device capable of communicating via a first RAT and second RAT in which communication using the first RAT is preferred. The method may include determining whether a condition warrants attempting a connection with the first RAT in response to the multi-mode wireless device communicating using the second RAT. The method may include, in response to determining that no condition warrants attempting a wireless connection using the first RAT, continuing to communicate using the second RAT for a first duration before again determining whether a condition warrants attempting a connection with the first RAT. The method may include determining whether a connection can be made to the first preferred RAT in response to determining that a condition warrants attempting a wireless connection using the first RAT.

Some aspects may include determining whether an identifier of a wireless communication cell currently providing the wireless connection using the second RAT differs from an identifier of a wireless communication cell providing the connection using the second RAT at a previous time. Some aspects may include determining that a condition warrants attempting a wireless connection using the first RAT in response to determining that the identifier of the wireless communication cell currently providing the wireless connection using the second RAT differs from the identifier of the wireless communication cell providing the connection using the second RAT at the previous time.

Some aspects may include storing in memory the identifier of the wireless communication cell providing the wireless connection using the second RAT. Some aspects may include determining an identifier of the wireless communication cell providing the wireless connection using the second RAT as part of a discontinuous reception (DRX) wake up procedure. Some aspects may include determining whether the identifier of the wireless communication cell determined as part of the DRX wake up procedure differs from the stored identifier of the wireless communication cell.

Some aspects may include determining whether there has been an increase in signal strength of received wireless communication signals. Some aspects may include deter mining that a condition warrants attempting a wireless connection using the first RAT in response to determining there has been an increase in signal strength of received wireless communication signals.

Some aspects may include storing in memory the signal strength of received wireless communication signals. Some aspects may include determining the signal strength of received wireless communication signals as part of an enhanced discontinuous reception (eDRX) wake up procedure. Some aspects may include determining whether the signal strength of received wireless communication signals determined as part of the eDRX wake up procedure exceeds the stored signal strength of received wireless communication signals by a threshold amount.

Some aspects may include determining whether a maximum coupling loss for a wireless connection using the first RAT is achievable. Some aspects may include deter mining that a condition warrants attempting a wireless connection using the first RAT in response to determining that the maximum coupling loss for a wireless connection using the first RAT is achievable.

In some aspects, determining whether a maximum coupling loss for a wireless connection using the first RAT is achievable may include determining a coupling loss for the second RAT, determining a transmit power of cell specific reference signals (CRS) and a transmit power of narrowband reference signals (NRS) from information included in System Information Block 2 (SIB2) signals, estimating a coupling loss for the first RAT based on the determined coupling loss of the second RAT and a ratio of the NRS transmit power to the CRS transmit power, and determining whether the estimated coupling loss for the first RAT satisfies a maximum coupling loss threshold for the first RAT. Some aspects may include determining a priority list of cells for the first RAT in response to determining that the estimated coupling loss for the first RAT satisfies the maximum coupling loss threshold for the first RAT.

Some aspects may include determining whether data from sensors within the wireless device indicates that the wireless device has moved. Some aspects may include deter mining that a condition warrants attempting a wireless connection using the first RAT in response to determining that the data from sensors within the wireless device indicates that the wireless device has moved.

Some aspects may include determining that an identifier of a wireless communication cell currently providing the wireless connection using the second RAT differs from an identifier of the wireless communication cell providing the connection using the second RAT at a previous time. Some aspects may include determining there has been an increase in signal strength of received wireless communication signals. Some aspects may include determining that the maximum coupling loss for a wireless connection using the first RAT is achievable. Some aspects may include determining from data from sensors within the wireless device that the wireless device has moved.

Some aspects may include determining whether the wireless device is communicating using the first RAT. Some aspects may include performing a scan for signals from a wireless communication cell using the first RAT. Some aspects may include starting a second timer in response to not receiving signals from a wireless communication cell using the first RAT. In some aspects, the second timer may be shorter than the first timer. In some aspects, determining whether a condition may warrant attempting a connection with the first RAT in response to the multi-mode wireless device communicating using the second RAT is performed in response to expiration of the second timer.

In some aspects, determining whether a connection can be made to the first preferred RAT may include starting the second timer again in response to determining that a condition warrants attempting a wireless connection using the first RAT.

Further aspects may include a wireless device having a processor configured to perform one or more operations of the methods summarized above. Further aspects may include a non-transitory processor-readable storage medium having stored thereon processor-executable instructions configured to cause a processor of a wireless device to perform operations of the methods summarized above. Further aspects include a wireless device having means for performing functions of the methods summarized above. Further aspects include a system on chip for use in a wireless device that includes a processor configured to perform one or more operations of the methods summarized above. Further aspects include a system in a package that includes two systems on chip for use in a wireless device that includes a processor configured to perform one or more operations of the methods summarized above.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIG. 1A is a system block diagram conceptually illustrating an example communications system including a small cell and a problem that can develop in such systems.

FIG. 1B is a diagram conceptually illustrating reception ranges of LTE, Cat. M, and NB-IoT RATs with respect to example IoT devices.

FIG. 2 is a component block diagram illustrating a computing system that may be configured to implement management of cell selection in accordance with various embodiments.

FIG. 3 is a component block diagram of an IoT device suitable for use in accordance with various embodiments.

FIG. 4 is a component block diagram illustrating a system configured for conserving power in a multi-mode wireless device capable of communicating via a first RAT and second RAT in which communication using the first RAT is preferred in accordance with various embodiments.

FIGS. 5A, 5B, 5C, 5D, 5E, 5F, 5G, 5H, SI, and/or 5J illustrate(s) operations of methods for conserving power in a multi-mode wireless device capable of communicating via a first RAT and a second RAT in which communication using the first RAT is preferred in accordance with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and embodiments are for illustrative purposes, and are not intended to limit the scope of the claims.

Various embodiments include methods and multi-mode wireless IoT devices configured to perform such methods of adjusting routines for scanning for service using a preferred RAT, such as the Cat. M, to avoid or minimize such scanning operations in circumstances in which service from the preferred RAT is unlikely, and permitting scanning operations in circumstances in which one or more conditions indicates there may have been a change in wireless service availability. Various embodiments may extend the battery endurance of IoT devices in such circumstances by avoid or minimizing the power drain of conducting a scan for wireless service using the preferred RAT, while enabling the IoT device to switch to the preferred RAT by permitting service scan when conditions indicate a switch to the preferred RAT might succeed.

The term “wireless device” is used herein to refer to any form of wireless-network enabled Internet of Things (IoT) devices including, but not limited to, smart meters/sensors, industrial manufacturing equipment, large and small machinery and appliances for home or enterprise use, and similar electronic devices that include a memory, wireless communication components and a programmable processor.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SOCs coupled together via high speed communication circuitry and packaged in close proximity, such as on a single motherboard or in a single wireless device. The proximity of the SOCs facilitates high speed communications and the sharing of memory and resources.

The term “multicore processor” may be used herein to refer to a single integrated circuit (IC) chip or chip package that contains two or more independent processing cores (e.g., CPU core, Internet protocol (IP) core, graphics processor unit (GPU) core, etc.) configured to read and execute program instructions. A SOC may include multiple multicore processors, and each processor in an SOC may be referred to as a core. The term “multiprocessor” may be used herein to refer to a system or device that includes two or more processing units configured to read and execute program instructions.

The two recently adopted LTE-based IoT communications standards have been developed to address different use cases and applications of IoT devices.

Cat. M functions on a 1.4 MHz (reduced from 20 MHz) spectrum, has a transmit power of 20 dBm, and provides average upload speeds between 200 kilobits per second (kpbs) and 400 kpbs. Cat M1 allows low-power, wide-area technologies to work with a licensed spectrum, which provides a secure and private network, possibly the number-one concern for businesses coming up with IoT initiatives. It works specifically with IoT applications with low to medium data usage and devices with long battery lifetimes.

The NB-IoT RAT was developed to provide improved indoor wireless coverage, support of massive number of low throughput devices, low delay sensitivity, ultra-low device cost, low device power consumption and optimized network architecture. The NB-IoT RAT can be deployed “in-band”, utilizing resource blocks within a normal LTE carrier, or in the unused resource blocks within an LTE carrier's guard-band or “standalone” for deployments in dedicated spectrum. The NB-IoT RAT is also particularly suitable for the re-farming of GSM channels.

Many IoT communications chips and devices have the ability to communicate using either Cat. M or NB-IoT, and are referred to as multimode devices. Also, in many network deployments, transceivers supporting both Cat. M and NB-IoT RATs will be employed on the same base station or eNB. The combination of multimode IoT devices and co-locating Cat. M or NB-IoT transceivers enable IoT devices to establish wireless communications using one or the other RAT. This enables IoT devices to operate in locations and under conditions that may cause one RAT to provide better communications than the other, providing flexibility to accommodate difference in applications and implementations. In particular, due to differences in the communication protocols, NB-IoT communications tend to transmit through buildings and other structures better than Cat. M signals. Consequently, a communication link may be established by IoT devices using the NB-IoT RAT when wireless service using the Cat. M RAT is not achievable.

Due to their different communication characteristics, the Cat. M RAT provides greater transmission bandwidth and flexibility compared to the NB-IoT RAT. As a result, manufacturers of IoT communications chips and devices are tending to set Cat. M as the preferred or default communication protocol.

The IoT communication protocols include a procedure implemented by IoT devices to periodically confirm or search for wireless service using a preferred RAT, such as Cat. M. This routine enables multimode IoT devices to switch back to the preferred RAT when such communication signals are available. Specifically, this routine sets a timer when the IoT device is forced to connect to a less preferred RAT (e.g., NB-IoT) because the preferred RAT (e.g., Cat. M) is not available. This timer permits the IoT device to use the less preferred RAT for a period of time, at the expiration of which the IoT device again attempts to connect to a preferred network by conducting a scan of frequencies associated with the preferred RAT. Thus, an IoT device configured by the manufacturer to use the Cat. M RAT preferentially will periodically attempt to establish connections with a base station using the Cat. M RAT when the IoT device is using the NB-IoT. This routine provides the advantage of ensuring that IoT devices use a preferred RAT for communications whenever such service is available and prevents the IoT device from locking in a less preferred RAT (e.g., NB-IoT), such as when the preferred RAT connection is temporarily not available.

However, this procedure has a disadvantage in some applications for IoT devices. At present, IoT devices are being deployed in a number of applications that are stationary. Further, the NB-IoT RAT is optimized for stationary IoT devices. Examples of stationary IoT devices include smart appliances, smart meters, fixed sensors, and a wide variety of other devices that are unlikely to move during the course of their useful lifetime. In such applications, the default routine for periodically attempting to establish a communication link with a base station using the preferred RAT will cause the IoT device to expend energy conducting a scan when detecting service using the preferred RAT is unlikely. In addition to the power drain of conducting a scan for service on the preferred RAT, multimode IoT devices are typically memory constrained, and therefore must swap out the modem software images in working memory to be able to switch between RATs, a process that requires time and consumes power.

Various embodiments include methods for conserving power in a multi-mode wireless device capable of communicating via a first RAT (e.g., Cat. M) and second RAT (e.g., NB-IoT) in which communication using the first RAT is preferred. In various embodiments, when a multi-mode IoT device is communicating using the second RAT (i.e., a non-preferred RAT, such as NB-IoT), a device processor may determine whether a condition warrants attempting a connection with the first RAT, such as by conducting a frequency scan for service using the first (i.e., preferred) RAT. A condition warranting scanning for service using the preferred RAT could be any event, information, status or sensor data providing an indication or hint that wireless service conditions have changed. So long as no condition warrants attempting a wireless connection using the first RAT, the IoT device may continue to communicate using the second RAT (i.e., a non-preferred RAT, such as NB-IoT) for a set duration (e.g., determined by setting a timer). The duration may be long enough to enable the IoT device to conserve power by avoiding checking the conditions too frequently, but short enough to enable the IoT device to switch to the preferred RAT soon after conditions have changed. After this duration (e.g., upon expiration of the timer), the processor may again determine whether a condition warrants attempting a connection with the first RAT. At any time that the processor determines that a condition warrants attempting a wireless connection using the first RAT, the processor may enable or initiate the service scan procedure to determine whether a connection can be made to the first preferred RAT.

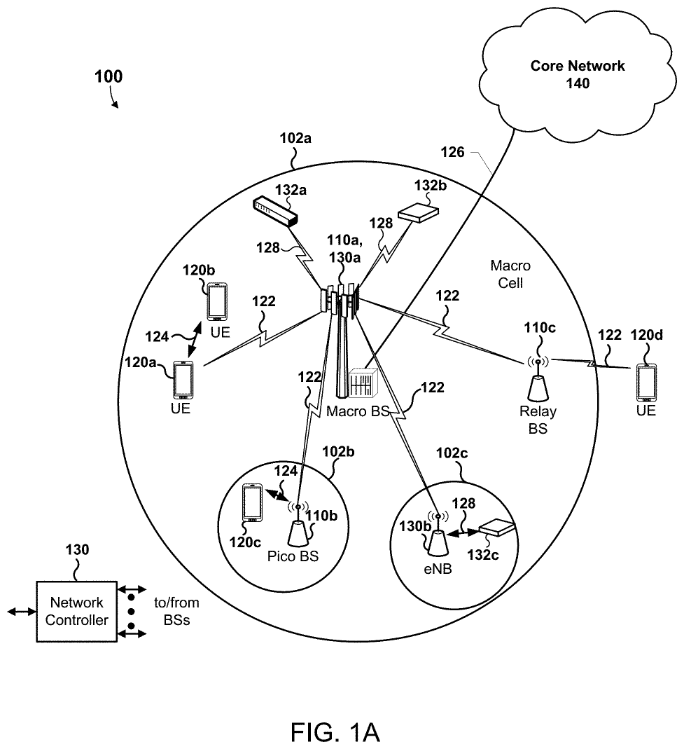

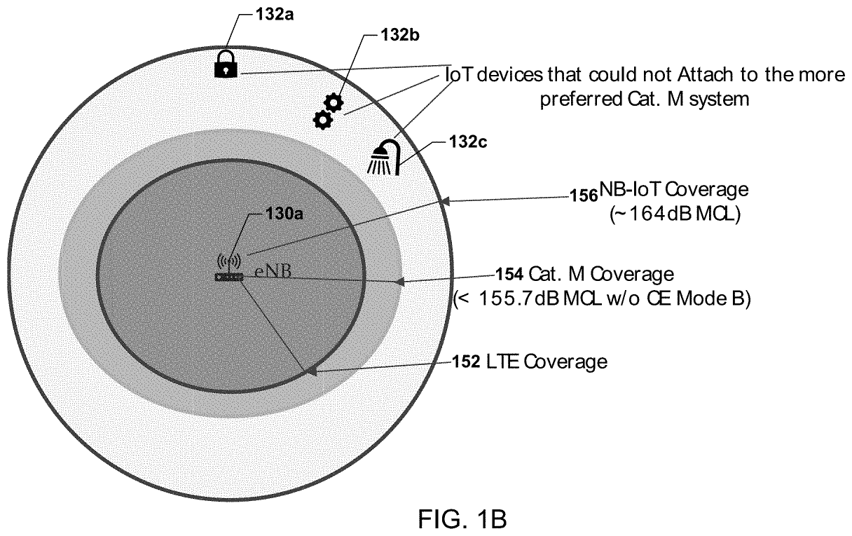

FIG. 1A illustrates an example of a communications system 100 that is suitable for implementing various embodiments. The communications system 100 may be an 5G NR network, or any other suitable network such as an LTE network.

The communications system 100 may include a heterogeneous network architecture that includes a core network 140 and a variety of mobile devices (illustrated as wireless device 120a-120d in FIG. 1), as well as IoT devices 132a, 132b, 132c. The communications system 100 may also include a number of base stations. A base station is an entity that communicates with wireless devices (mobile devices), and also may be referred to as an NodeB, a Node B, an LTE evolved nodeB (eNB), an access point (AP), a radio head, a transmit receive point (TRP), a New Radio base station (NR BS), a 5G NodeB (NB), a Next Generation NodeB (gNB), or the like. Base stations are illustrated in FIG. 1A as the BS 110a, 130a, the BS 110b, the BS 110c, and the eNB 130b and other network entities. Each base station may provide communication coverage for a particular geographic area. The term “cell” can refer to a coverage area of a base station, a base station subsystem serving this coverage area, or a combination thereof, depending on the context in which the term is used.

A base station 110a-110c and eNB 130a-130b may provide communication coverage for a macro cell, a pico cell, a femto cell, another type of cell, or a combination thereof. A macro cell may cover a relatively large geographic area (for example, several kilometers in radius) and may allow unrestricted access by mobile devices with service subscription. A pico cell may cover a relatively small geographic area and may allow unrestricted access by mobile devices with service subscription. A femto cell may cover a relatively small geographic area (for example, a home) and may allow restricted access by mobile devices having association with the femto cell (for example, mobile devices in a closed subscriber group (CSG)). A base station for a macro cell may be referred to as a macro BS. A base station for a pico cell may be referred to as a pico BS. A base station for a femto cell may be referred to as a femto BS or a home BS. In the example illustrated in FIG. 1A, a base station 110a may be a macro BS for a macro cell 102a, a base station 110b may be a pico BS for a pico cell 102b, and a base station 110c may be a femto BS for a femto cell 102c. A base station 110a-110c and eNB 130a-130b may support one or multiple (for example, three) cells. The terms “eNB”, “base station”, “NR BS”, “gNB”, “TRP”, “AP”, “node B”, “5G NB”, and “cell” may be used interchangeably herein.

In some examples, a cell may not be stationary, and the geographic area of the cell may move according to the location of a mobile base station. In some examples, the base stations 110a-110c and eNB 130a-130b may be interconnected to one another as well as to one or more other base stations or network nodes (not illustrated) in the communications system 100 through various types of backhaul interfaces, such as a direct physical connection, a virtual network, or a combination thereof using any suitable transport network

The base station 110a-110c and eNB 130a-130b may communicate with the core network 140 over a wired or wireless communication link 126. The wireless devices 120a-120d may communicate with the base station 110a-110c over a wireless communication link 122. The IoT devices 132a-132c may communicate with eNBs 130a, 130b over IoT RAT wireless communication links 128, such as using the Cat. M RAT or NB-IoT RAT.

The wired communication link 126 may use a variety of wired networks (e.g., Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

The communications system 100 also may include relay stations (e.g., relay BS 110c). A relay station is an entity that can receive a transmission of data from an upstream station (for example, a base station or a mobile device) and send a transmission of the data to a downstream station (for example, a wireless device or a base station). A relay station also may be a mobile device that can relay transmissions for other wireless devices. In the example illustrated in FIG. 1A, a relay station 110c may communicate with macro the base station 110a and the wireless device 120d in order to facilitate communication between the base station 110a and the wireless device 120d. A relay station also may be referred to as a relay base station, a relay base station, a relay, etc.

The communications system 100 may be a heterogeneous network that includes base stations of different types, for example, macro base stations, pico base stations, femto base stations, relay base stations, etc. These different types of base stations may have different transmit power levels, different coverage areas, and different impacts on interference in communications system 100. For example, macro base stations may have a high transmit power level (for example, 5 to 40 Watts) whereas pico base stations, femto base stations, and relay base stations may have lower transmit power levels (for example, 0.1 to 2 Watts).

A network controller 130 may couple to a set of base stations and may provide coordination and control for these base stations. The network controller 130 may communicate with the base stations via a backhaul. The base stations also may communicate with one another, for example, directly or indirectly via a wireless or wireline backhaul.

The wireless devices 120a, 120b, 120c may be dispersed throughout communications system 100, and each wireless device may be stationary or mobile. A wireless device also may be referred to as an access terminal, a terminal, a mobile station, a subscriber unit, a station, etc. IoT devices 132a-132c may also be dispersed throughout communications system 100, and are typically stationary.

A macro base station 110a may communicate with the communication network 140 over a wired or wireless communication link 126. The wireless devices 120a, 120b, 120c may communicate with a base station 110a-110c over a wireless communication link 122.

The wireless communication links 122, 124, 128 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (e.g., NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links 122, 124 within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE). The IoT RATs may include Cat. M and NB-IoT.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block”) may be 12 subcarriers (or 180 kHz). Consequently, the nominal Fast File Transfer (FFT) size may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

While descriptions of some embodiments may use tell sinology and examples associated with LTE technologies, various embodiments may be applicable to other wireless communications systems, such as a new radio (NR) or 5G network. NR may utilize OFDM with a cyclic prefix (CP) on the uplink (UL) and downlink (DL) and include support for half-duplex operation using time division duplex (TDD). A single component carrier bandwidth of 100 MHz may be supported. NR resource blocks may span 12 sub-carriers with a sub-carrier bandwidth of 75 kHz over a 0.1 ms duration. Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL control data. Beamforming may be supported and beam direction may be dynamically configured. Multiple Input Multiple Output (MIMO) transmissions with precoding may also be supported. MIMO configurations in the DL may support up to eight transmit antennas with multi-layer DL transmissions up to eight streams and up to two streams per wireless device. Multi-layer transmissions with up to 2 streams per wireless device may be supported. Aggregation of multiple cells may be supported with up to eight serving cells. Alternatively, NR may support a different air interface, other than an OFDM-based air interface.

In general, any number of communications systems and any number of wireless networks may be deployed in a given geographic area. Each communications system and wireless network may support a particular radio access technology (RAT) and may operate on one or more frequencies. A RAT also may be referred to as a radio technology, an air interface, etc. A frequency also may be referred to as a carrier, a frequency channel, etc. Each frequency may support a single RAT in a given geographic area in order to avoid interference between communications systems of different RATs. In some cases, NR or 5G RAT networks may be deployed.

In some embodiments, two or more mobile devices 120a-120d (for example, illustrated as the wireless device 120a and the wireless device 120b) may communicate directly using one or more sidelink channels 124 (for example, without using a base station 110a-110c as an intermediary to communicate with one another). For example, the wireless devices 120a-120d may communicate using peer-to-peer (P2P) communications, device-to-device (D2D) communications, a vehicle-to-everything (V2X) protocol (which may include a vehicle-to-vehicle (V2V) protocol, a vehicle-to-infrastructure (V2I) protocol, or similar protocol), a mesh network, or similar networks, or combinations thereof. In this case, the wireless device 120a-120d may perform scheduling operations, resource selection operations, as well as other operations described elsewhere herein as being performed by the base station 110a.

As noted above, due to the better longer communication path length of the NB-IoT RAT signals, particularly in urban and industrial settings, it is likely that a significant fraction of deployed IoT devices will only be able to receive NB-IoT RAT signals because the devices are located outside the effective communication range of Cat. M RAT signals. This situation is illustrated in FIG. 1B, which notionally illustrates how NB-IoT coverage 156 exceeds the Cat. M coverage 154, both of which extend beyond the LTE coverage 152 from a given dNB 130a. With reference to FIGS. 1A and 1B, FIG. 1B illustrates how some fixed-location IoT devices 132a, 132b, 132c can be positioned where each can receive wireless service from an eNB 130a using the NB-IoT RAT but cannot receive wireless service using the Cat. M RAT.

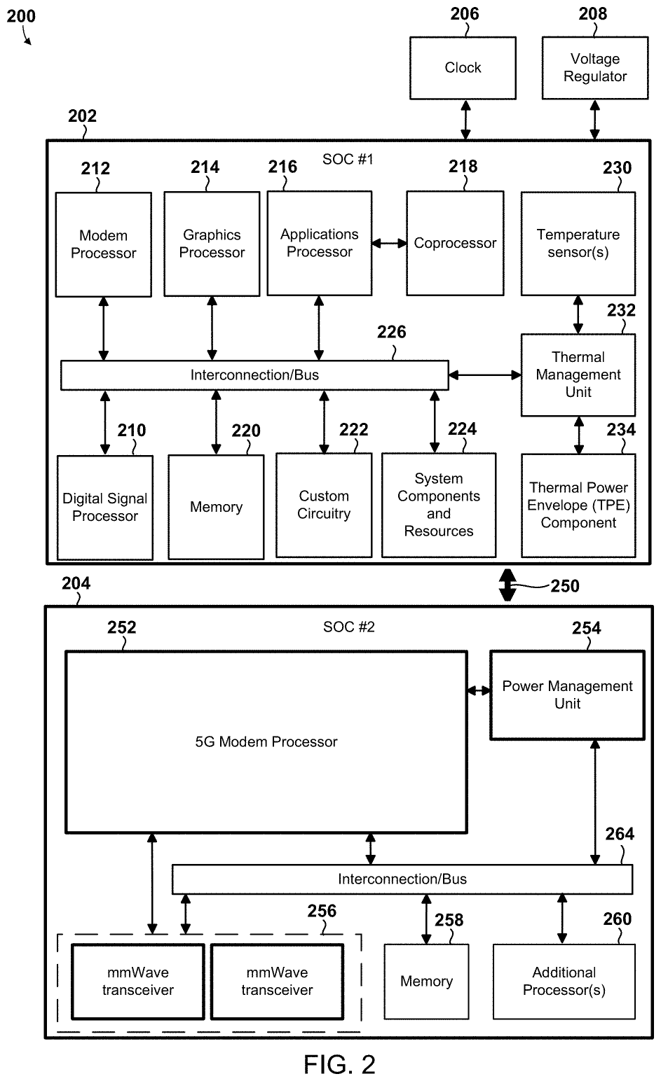

Various embodiments may be implemented on a number of single processor and multiprocessor computer systems, including a system-on-chip (SOC) or system in a package (SIP). FIG. 2 illustrates an example computing system or SIP 200 architecture that may be used in wireless devices implementing various embodiments.

With reference to FIGS. 1A-2, the illustrated example SIP 200 includes a two SOCs 202, 204, a clock 206, and a voltage regulator 208. In some embodiments, the first SOC 202 operate as central processing unit (CPU) of the wireless device that carries out the instructions of software application programs by performing the arithmetic, logical, control and input/output (I/O) operations specified by the instructions. In some embodiments, the second SOC 204 may operate as a specialized processing unit. For example, the second SOC 204 may operate as a specialized 5G processing unit responsible for managing high volume, high speed (e.g., 5 Gbps, etc.), and/or very high frequency short wave length (e.g., 28 GHz mmWave spectrum, etc.) communications.

The first SOC 202 may include a digital signal processor (DSP) 210, a modem processor 212, a graphics processor 214, an application processor 216, one or more coprocessors 218 (e.g., vector co-processor) connected to one or more of the processors, memory 220, custom circuitry 222, system components and resources 224, an interconnection/bus module 226, one or more temperature sensors 230, a thermal management unit 232, and a thermal power envelope (TYPE) component 234. The second SOC 204 may include a 5G modem processor 252, a power management unit 254, an interconnection/bus module 264, a plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (e.g., FreeBSD, LINUX, OS X, etc.) and a processor that executes a second type of operating system (e.g., MICROSOFT WINDOWS 10). In addition, any or all of the processors 210, 212, 214, 216, 218, 252, 260 may be included as part of a processor cluster architecture (e.g., a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a wireless device. The system components and resources 224 and/or custom circuitry 222 may also include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates and/or implement a bus architecture (e.g., CoreConnect, AMBA, etc.). Communications may be provided by advanced interconnects, such as high-performance networks-on chip (NoCs).

The first and/or second SOCs 202, 204 may further include an input/output module (not illustrated) for communicating with resources external to the SOC, such as a clock 206 and a voltage regulator 208. Resources external to the SOC (e.g., clock 206, voltage regulator 208) may be shared by two or more of the internal SOC processors/cores.

In addition to the example SIP 200 discussed above, various embodiments may be implemented in a wide variety of computing systems, which may include a single processor, multiple processors, multicore processors, or any combination thereof.

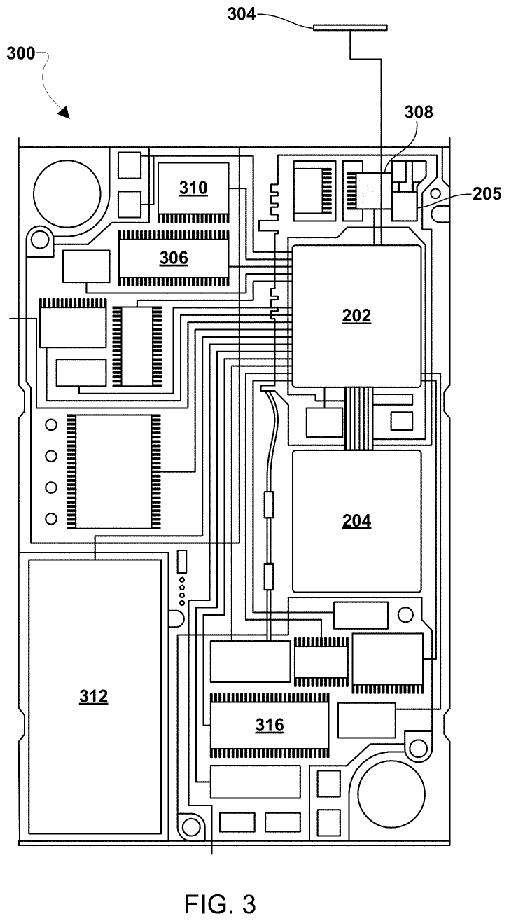

The various embodiments may be implemented on a variety of IoT devices, an example in the form of a circuit board for use in a device is illustrated in FIG. 3. With reference to FIGS. 1A-3, an IoT device 300 may include a first SOC 202 (e.g., a SOC-CPU) coupled to a second SOC 204 (e.g., a 5G capable SOC) and a temperature sensor 205. The first and second SOCs 202, 204 may be coupled to internal memory 306. Additionally, the IoT device 300 may include or be coupled to an antenna 304 for sending and receiving wireless signals from a cellular telephone transceiver 308 or within the second SOC 204. The antenna 304 and transceiver 308 and/or second SOC 204 may support communications using various RATs, including LTE Cat. M, NB-IoT, CIoT, GSM, and/or VoLTE.

Some IoT devices 300 may include a sound encoding/decoding (CODEC) circuit 310, which digitizes sound received from a microphone into data packets suitable for wireless transmission and decodes received sound data packets to generate analog signals that are provided to a speaker to generate sound in support of voice or VoLTE calls. Also, one or more of the processors in the first and second SOCs 202, 204, wireless transceiver 308 and CODEC 310 may include a digital signal processor (DSP) circuit (not shown separately).

Some IoT devices may include an internal power source, such as a battery 312 configured to power the SOCs and transceiver(s). Such IoT devices may include power management components 316 to manage charging of the battery 312.

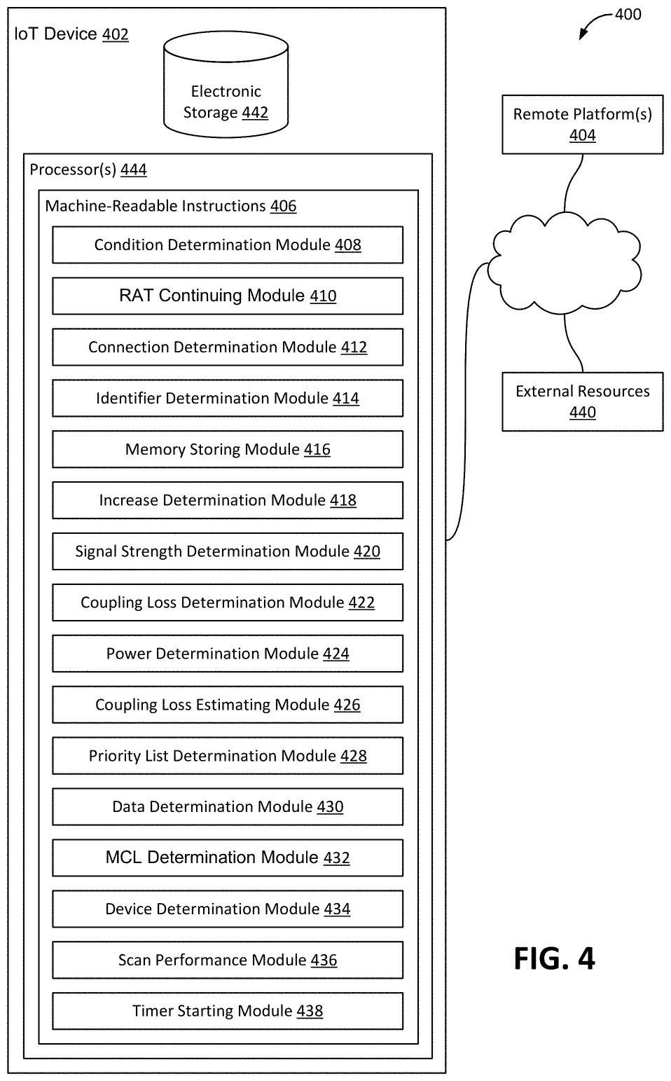

FIG. 4 is a component block diagram illustrating a system 400 configured for conserving power in a multi-mode wireless device capable of communicating via a first radio access technology and second RAT in which communication using the first RAT is preferred in accordance with various embodiments. In some embodiments, system 400 may include one or more computing platforms 402 and/or one or more remote platforms 404. With reference to FIGS. 1A-4, computing platform(s) 402 may include a base station (e.g., the base station 110a-110c eNB 130a-130b) and/or a wireless device (e.g., the wireless device 120a-120d, 132a-132c, 200, 300). Remote platform(s) 404 may include a base station (e.g., the base station 110a-110c eNB 130a-130b) and/or a wireless device (e.g., the wireless device 120a-120d, 132a-132c, 200, 300).

Computing platform(s) 402 may be configured by machine-readable instructions 406. Machine-readable instructions 406 may include one or more instruction modules. The instruction modules may include computer program modules. The instruction modules may include one or more of condition determination module 408, RAT continuing module 410, connection determination module 412, identifier determination module 414, memory storing module 416, increase determination module 418, signal strength determination module 420, coupling loss determination module 422, power determination module 424, coupling loss estimating module 426, priority list determination module 428, data determination module 430, maximum coupling loss determination module 432, device determination module 434, scan performance module 436, timer starting module 438, and/or other instruction modules.

Condition determination module 408 may be configured to determine whether a condition warrants attempting a connection with the first RAT in response to the multi-mode wireless device communicating using the second RAT.

Condition determination module 408 may be configured to determine that a condition warrants attempting a wireless connection using the first RAT in response to determining that the identifier of the wireless communication cell currently providing the wireless connection using the second RAT differs from the identifier of the wireless communication cell providing the connection using the second RAT at the previous time.

Condition determination module 408 may be configured to determine that a condition warrants attempting a wireless connection using the first RAT in response to determining there has been an increase in signal strength of received wireless communication signals.

Condition determination module 408 may be configured to determine that a condition warrants attempting a wireless connection using the first RAT in response to determining that the maximum coupling loss for a wireless connection using the first RAT is achievable.

Condition determination module 408 may be configured to determine that a condition warrants attempting a wireless connection using the first RAT in response to determining that the data from sensors within the wireless device indicates that the wireless device has moved.

RAT continuing module 410 may be configured to, in response to determining that no condition warrants attempting a wireless connection using the first RAT, continue to communicate using the second RAT for a first duration before again determining whether a condition warrants attempting a connection with the first RAT.

Connection determination module 412 may be configured to determine whether a connection can be made to the first preferred RAT in response to determining that a condition warrants attempting a wireless connection using the first RAT.

Identifier determination module 414 may be configured to determine whether an identifier of a wireless communication cell currently providing the wireless connection using the second RAT differs from an identifier of a wireless communication cell providing the connection using the second RAT at a previous time.

Identifier determination module 414 may be configured to determine an identifier of the wireless communication cell providing the wireless connection using the second RAT as part of a discontinuous reception (DRX) wake up procedure.

Identifier determination module 414 may be configured to determine whether the identifier of the wireless communication cell determined as part of the DRX wake up procedure differs from the stored identifier of the wireless communication cell.

Identifier determination module 414 may be configured to determine that an identifier of a wireless communication cell currently providing the wireless connection using the second RAT differs from an identifier of the wireless communication cell providing the connection using the second RAT at a previous time.

Memory storing module 416 may be configured to store in memory the identifier of the wireless communication cell providing the wireless connection using the second RAT.

Memory storing module 416 may be configured to store in memory the signal strength of received wireless communication signals.

Increase determination module 418 may be configured to determine whether there has been an increase in signal strength of received wireless communication signals.

Increase determination module 418 may be configured to determine there has been an increase in signal strength of received wireless communication signals.

Signal strength determination module 420 may be configured to determine the signal strength of received wireless communication signals as part of an enhanced discontinuous reception (eDRX) wake up procedure.

Signal strength determination module 420 may be configured to determine whether the signal strength of received wireless communication signals determined as part of the eDRX wake up procedure exceeds the stored signal strength of received wireless communication signals by a threshold amount.

Coupling loss determination module 422 may be configured to determine whether a maximum coupling loss for a wireless connection using the first RAT is achievable.

Coupling loss determination module 422 may be configured to determine a coupling loss for the second RAT.

Coupling loss determination module 422 may be configured to determine whether the estimated coupling loss for the first RAT satisfies a maximum coupling loss threshold for the first RAT.

Power determination module 424 may be configured to determine a transmit power of cell specific reference signals (CRS) and a transmit power of narrowband reference signals (NRS) from information included in SIB2 signals.

Coupling loss estimating module 426 may be configured to estimate coupling loss for the first RAT based on the determined coupling loss of the second RAT and a ratio of the NRS transmit power to the CRS transmit power.

Priority list determination module 428 may be configured to determine a priority list of cells for the first RAT in response to determining that the estimated coupling loss for the first RAT satisfies a maximum coupling loss threshold for the first RAT.

Data determination module 430 may be configured to determine whether data from sensors within the wireless device indicates that the wireless device has moved.

Data determination module 430 may be configured to determine from data from sensors within the wireless device whether the wireless device has moved.

Maximum coupling loss determination module 432 may be configured to determine whether the maximum coupling loss for a wireless connection using the first RAT is achievable.

Device determination module 434 may be configured to determine whether the wireless device is communicating using the first RAT.

Scan performance module 436 may be configured to perform a scan for signals from a wireless communication cell using the first RAT.

Timer starting module 438 may be configured to start a second timer in response to not receiving signals from a wireless communication cell using the first RAT. Determining whether a condition may warrant attempting a connection with the first RAT in response to the multi-mode wireless device communicating using the second RAT may be performed in response to expiration of the second timer. Determining whether a connection can be made to the first preferred RAT may include starting the second timer again in response to determining that a condition warrants attempting a wireless connection using the first RAT. The second timer may be shorter than the first timer.

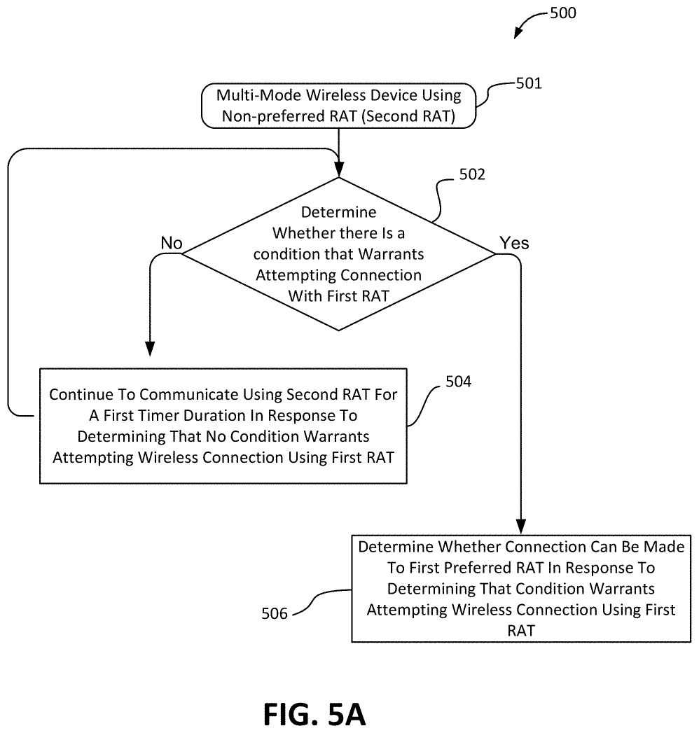

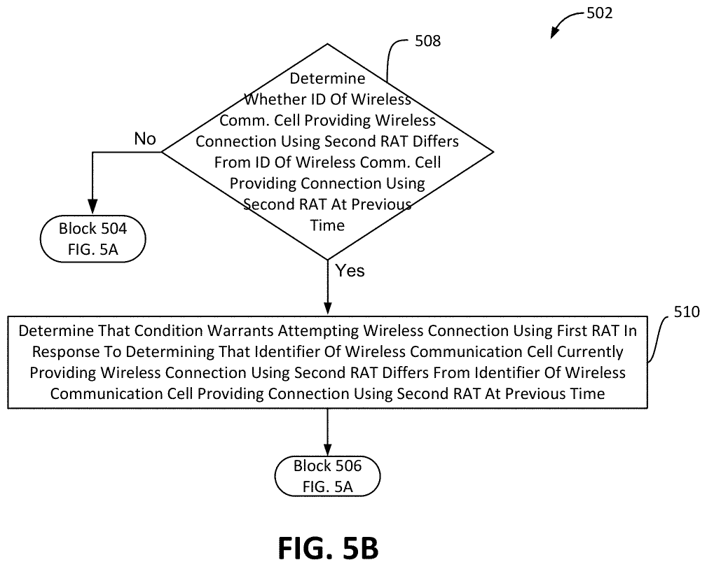

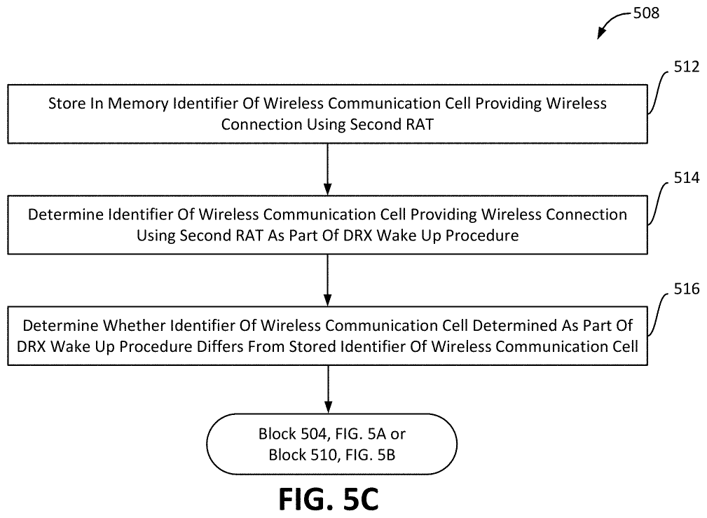

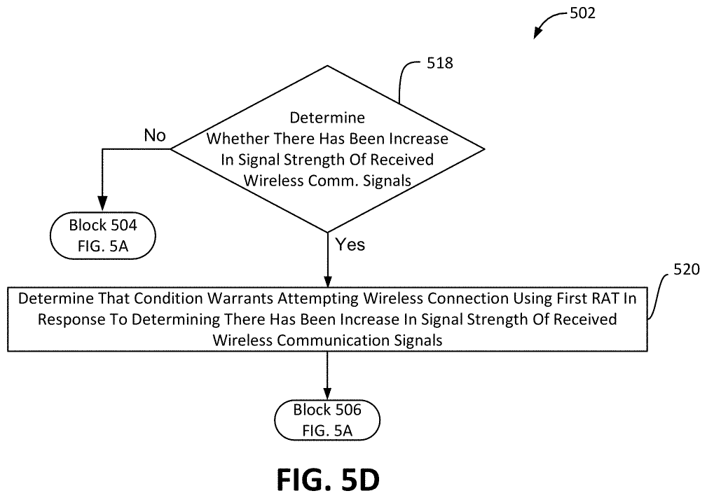

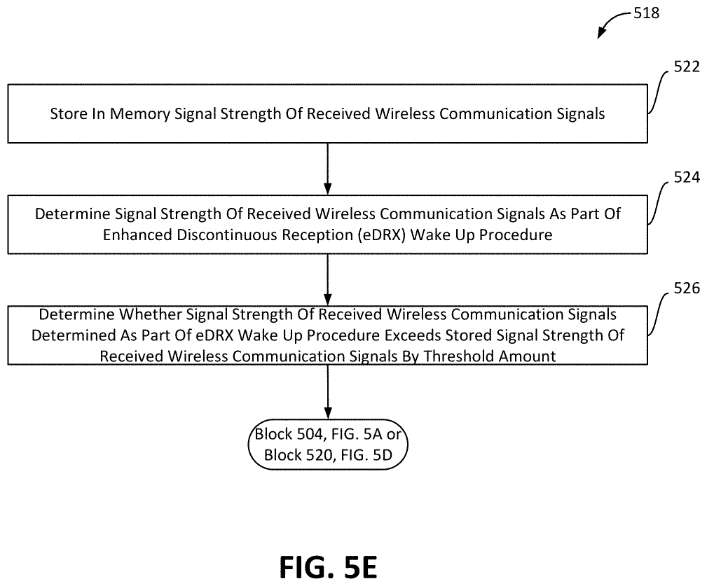

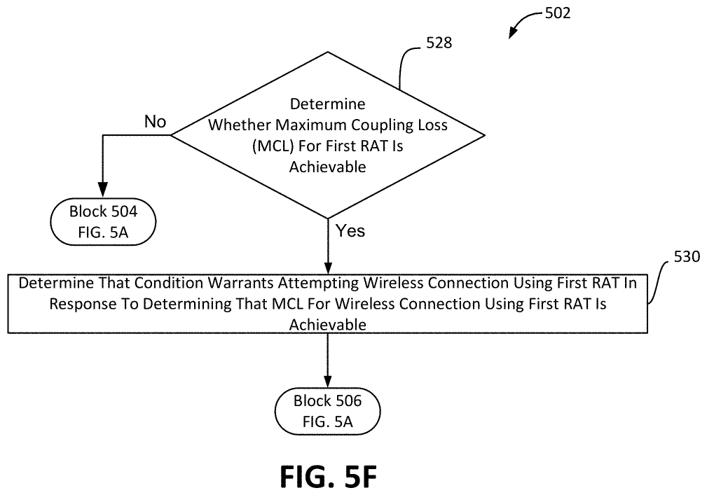

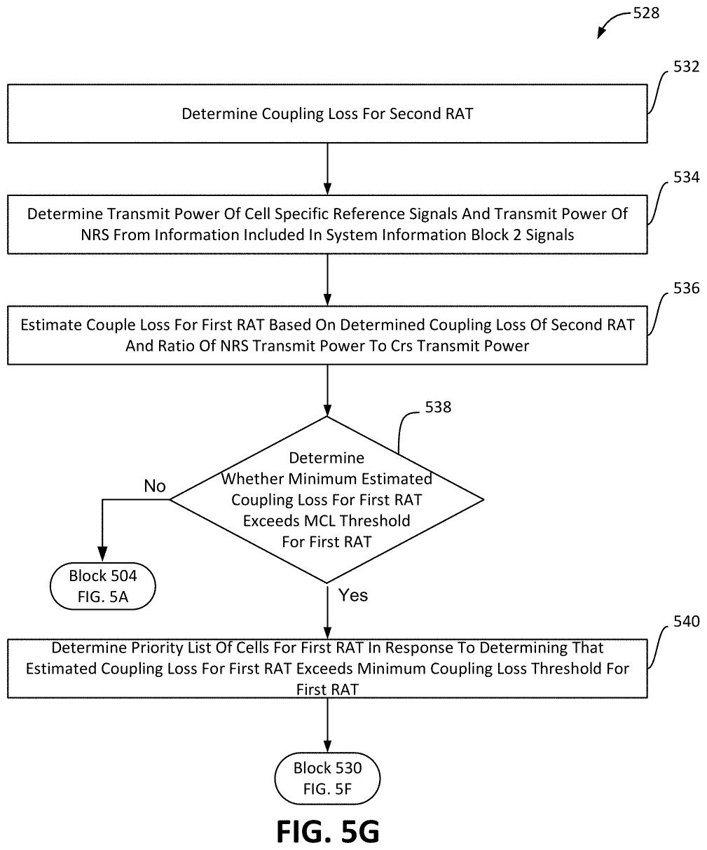

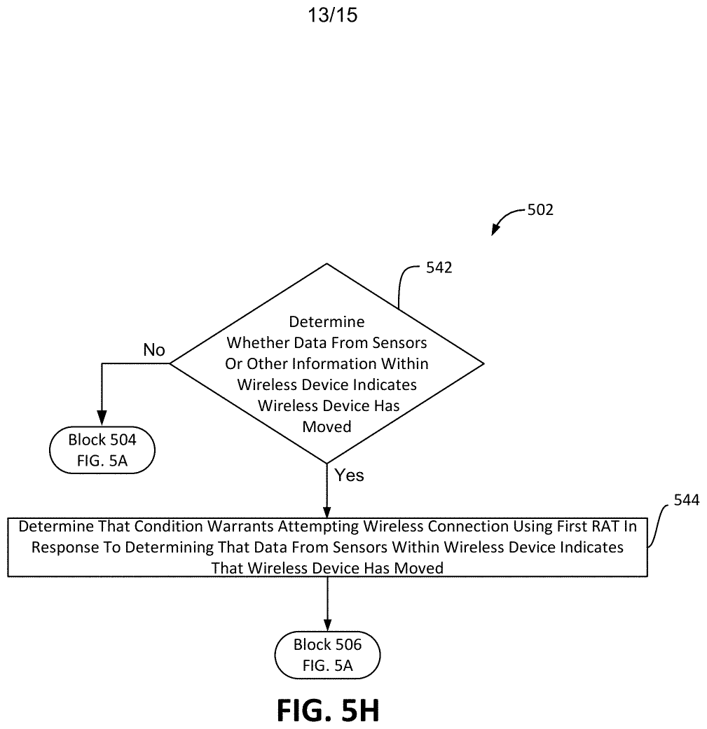

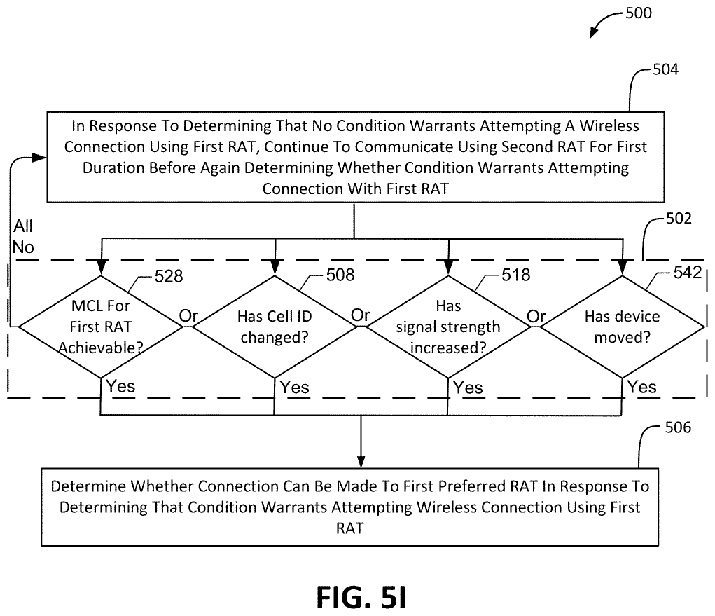

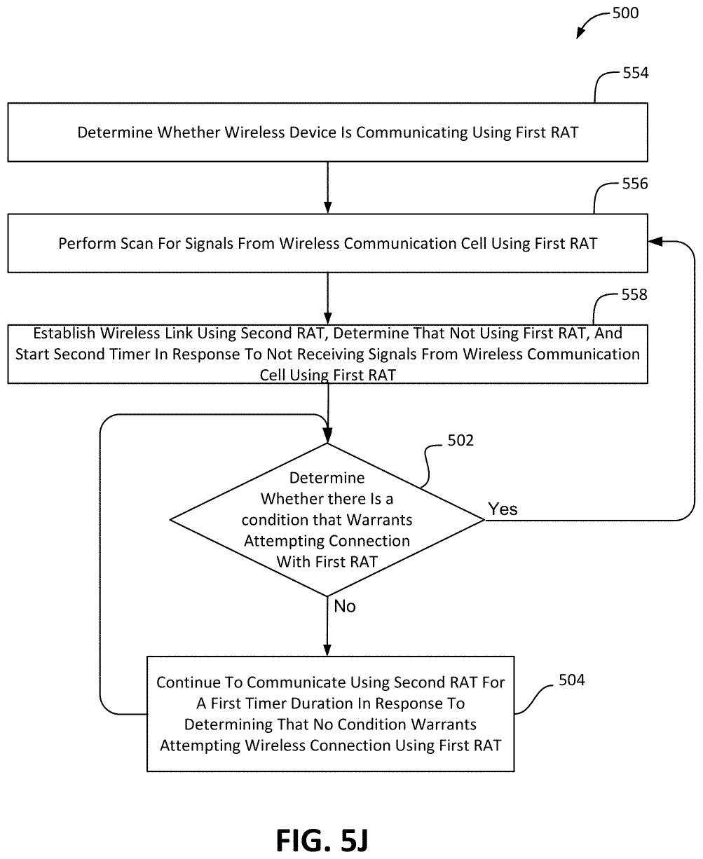

FIGS. 5A, 5B, 5C, 5D, 5E, 5F, 5G, 5H, 5I, and/or 5J illustrate(s) operations of a method 500 for conserving power in a multi-mode wireless device capable of communicating via a first RAT and second RAT in which communication using the first RAT is preferred in accordance with various embodiments. The operations of the method 500 presented below are intended to be illustrative. In some embodiments, the method 500 may be accomplished with one or more additional operations not described, and/or without one or more of the operations discussed. Additionally, the order in which the operations of the method 500 are illustrated in FIGS. 5A, 5B, 5C, 5D, 5E, 5F, 5G, 5H, 5I, and/or 5J, and described below, is not intended to be limiting.

In some embodiments, the method 500 may be implemented in one or more processors (e.g., a modem processor 212 or an application processor 216 of the IoT device). The one or more processors may include one or more devices executing some or all of the operations of the method 500 in response to instructions stored electronically on an electronic storage medium. The one or more processors may include one or more devices configured through hardware, firmware, and/or software to be specifically designed for execution of one or more of the operations of the method 500.

With reference to FIGS. 1A-5A, in block 502, the processor may determine whether a condition warrants attempting a connection with the first RAT in response to the multi-mode wireless device communicating using the second RAT. Operations performed by the processor resulting in the IoT wireless device using the second RAT (block 501) are described with reference to FIG. 5J. A variety of conditions may indicate that scanning for service using the first RAT has a probability of succeeding exceeding a threshold, examples of which are described with reference to FIGS. 5B-5I.

In block 504, in response to determining that no condition warrants attempting a wireless connection using the first RAT, the processor may continue to communicate using the second RAT for a first duration (e.g., by setting a timer for the first duration) before again determining whether a condition warrants attempting a connection with the first RAT. The first duration may be preset or adjusted by manufacturers and service providers, and may depend upon the type of application for which the IoT device is designed. For example, for an IoT device designed for a stationary application, such as a sensor to be fixed to a particular device or in a set location, a smart meter or a smart appliance, the first duration may be on the order of four to eight hours (e.g., 6 hours). As another example, for an IoT device designed for an application that has low mobility, such as a sensor for use on construction equipment (e.g., on a sky crane), factory equipment, or other objects that may be moved from time to time, the first duration may be on the order of eight to twelve minutes (e.g., 10 minutes). As further example, for an IoT device designed for a mobile application, such as a sensor for use on a vehicle or trailer, or on equipment that will be moved frequently, the first duration may be on the order of one to three minutes (e.g., 2 minutes). These examples of the first duration that may be used in various applications are for the purpose of illustration and are not intended to be limiting unless specifically recited in a claim.

In block 506, the processor may determine whether a connection can be made to the first preferred RAT in response to determining that a condition warrants attempting a wireless connection using the first RAT.

FIG. 5B illustrates operations that may be performed as part of the operations of block 502 of the method 500 in some embodiments.

With reference to FIGS. 1-5B, in block 508, the processor may determine whether an identifier of a wireless communication cell currently providing the wireless connection using the second RAT differs from an identifier of a wireless communication cell providing the connection using the second RAT at a previous time. If not (i.e., block 508=“No”), the processor may continue to use the second RAT and perform the operations of block 504 as described.

In block 510, the processor may determine that a condition warrants attempting a wireless connection using the first RAT in response to deter mining that the identifier of the wireless communication cell currently providing the wireless connection using the second RAT differs from the identifier of the wireless communication cell providing the connection using the second RAT at the previous time (i.e., block 508=“Yes”). The processor may then perform the operations of block 506 of the method 500 as described.

FIG. 5C illustrates operations that may be performed as part of the operations of block 508 of the method 500, in accordance with one or more embodiments.

With reference to FIGS. 1-5C, in block 512, the processor may store in memory the identifier of the wireless communication cell providing the wireless connection using the second RAT.

In block 514, the processor may determine an identifier of the wireless communication cell providing the wireless connection using the second RAT as part of a DRX wake up procedure.

In block 516, the processor may determine whether the identifier of the wireless communication cell determined as part of the DRX wake up procedure differs from the stored identifier of the wireless communication cell. The processor may then perform the operations of block 504 of the method 500 (FIG. 5A) or block 510 of the method 500 (FIG. 5B) as described.

FIG. 5D illustrates operations that may be performed as part of the operations of block 502 of the method 500 in some embodiments.

With reference to FIGS. 1-5D, in block 518, the processor may determine whether there has been an increase in signal strength of received wireless communication signals. If not (i.e., block 518=“No”), the processor may continue to use the second RAT and perform the operations of block 504 as described.

In block 520, the processor may determine that a condition warrants attempting a wireless connection using the first RAT in response to determining there has been an increase in signal strength of received wireless communication signals (i.e., block 518=“Yes). The processor may then perform the operations of block 506 of the method 500 (FIG. 5A) as described.

FIG. 5E illustrates operations that may be performed as part of the operations of block 518 of the method 500, in accordance with one or more embodiments.

With reference to FIGS. 1-5E, in block 522, the processor may store in memory the signal strength of received wireless communication signals.

In block 524, the processor may determine the signal strength of received wireless communication signals as part of an eDRX wake up procedure.

In block 526, the processor may determine whether the signal strength of received wireless communication signals determined as part of the eDRX wake up procedure exceeds the stored signal strength of received wireless communication signals by a threshold amount. The processor may then perform the operations of block 520 of the method 500 (FIG. 5D) or block 504 of the method 500 (FIG. 5A) as described.

FIG. 5F illustrates operations that may be performed as part of the operations of block 502 of the method 500 in some embodiments.

With reference to FIGS. 1-5F, in block 528, the processor may determine whether a maximum coupling loss (“MCL” in the figures) for a wireless connection using the first RAT is achievable. If not (i.e., block 528=“No”), the processor may continue to use the second RAT and perform the operations of block 504 as described.

In block 530, the processor may determine that a condition warrants attempting a wireless connection using the first RAT in response to deter mining that the maximum coupling loss for a wireless connection using the first RAT is achievable (i.e., block 528=“Yes”). The processor may then perform the operations of block 506 of the method 500 (FIG. 5A) as described.

FIG. 5G illustrates operations that may be performed as part of the operations of block 528 of the method 500, in accordance with one or more embodiments.

With reference to FIGS. 1-5G, in block 532, the processor may determine a coupling loss for the second RAT. The coupling loss for the communication cell on which the wireless device is currently camped can be estimated based upon the NRS transmit power, which can be determined based on information included in the SIB2 message, and the received power of the NRS signal measured by the wireless device, such as by subtracting the measured signal power from the known transmitted power.

In block 534, the processor may determine a transmit power of the LTE cell specific reference signal (CRS) and the transmit power of the narrowband reference signal (NRS) from information included in System Information Block 2 (SIB2) signals if the SIB2 provides the Inband-SamePCI information.

In block 536, the processor may estimate coupling loss for the first RAT based on the determined coupling loss of the second RAT and a ratio of the NRS transmit power to the CRS transmit powers. Thus, determining the coupling loss for the NB-IoT RAT in block 532 and using SIB2 information on NRS and CRS transmit powers determined in block 534 enables the processor to estimate the coupling loss for the CAT-M1 RAT to be the NB-IoT coupling loss times the ratio of the NRS to CRS transmit power values. If the communication cell is using different physical cell identifier (PCI) and guard bands, the wireless device can use a worst case coupling loss assumption, such as 12 dB.

In block 538, the processor may determine whether the estimated coupling loss for the first RAT satisfies a maximum coupling loss coverage threshold (M1_MCL_TH) for the first RAT. For example, the processor may determine whether the estimated coupling loss that would be exhibited by signals of the first RAT is equal to or less than the maximum coupling loss that can be accommodated by a first RAT wireless connection. The coverage threshold value (M1_MCL_TH) for the Cat-M1 RAT (first RAT) may be determined based on the minimum link quality needed to maintain a wireless connection with the eNB using the first RAT. The coverage threshold value may also take into consideration a required performance for the Cat-M1 RAT based on the communication link requirements of the wireless device, an application executing on the wireless device, or a function performed by the wireless device. For example, if an application or function performed by the wireless device does not transmit or receive large amounts of data and/or can tolerate large bit error rates, the coverage threshold may be set lower, such as to the minimum link quality needed to maintain a wireless connection with the eNB, than if the an application or function performed by the wireless device requires transmission/reception of large amounts of data with low data rates.

If the estimated coupling loss does not satisfy the coverage threshold value (M1_MCL_TH), such as the estimated coupling loss is greater than the maximum coupling loss that can be sustained in a wireless connection using the first RAT, the probability of finding a Cat-M1 RAT cell is low. Therefore, in response to determining that the estimated coupling loss for the first RAT does not satisfy the maximum coupling loss threshold for the first RAT (i.e., block 538=“No”), the processor can save power that would have been expended otherwise by continuing to use the NB-IoT RAT service and avoid scanning for a Cat-M1 RAT cell in block 504 as described.

If the estimated coupling loss satisfies the coverage threshold value (M1_MCL_TH) (i.e., the signal strength and link quality are good enough to meet minimum reception requirements), the probability of finding a Cat-M1 RAT cell is high enough to warrant expending the power to perform a coverage search for wireless service using the first (i.e., preferred) RAT. Therefore, in block 540, the processor may determine a priority list of cells for the first RAT in response to determining that the estimated coupling loss for the first RAT exceeds minimum coupling loss threshold for the first RAT (i.e., block 538=“Yes”). The wireless device can use the frequency of the NB-IoT RAT service to determine a priority list of cells for conducting a scan for cells using the Cat-M1 RAT. For example, if the NB-IoT RAT is provided in-band using the same PCI mode, the LTE/Cat.-M1 center frequency can be calculated by adding to the NB center frequency the product of the index to the mid Physical Resource Block (PRG) times 100 Hz (i.e., indextomidPRB*100 KHz). Further the LTE cell ID and the CRS ports can be determined from information available via the NB-IoT RAT service. As another example, if the in-band PCI and guard band are different, there is high probability that an LTE/Cat.-M1 center frequency can be found within plus or minus 20 MHz of the NB-IoT RAT center frequency. The processor may then perform the operations of block 530 of the method 500 (FIG. 5F) as described.

FIG. 5H illustrates operations that may be performed as part of the operations of block 502 of the method 500 in some embodiments.

With reference to FIGS. 1-5H, in block 542, the processor may determine whether data from sensors within the wireless device indicates that the wireless device has moved. If not (i.e., block 542=“No”), the processor may continue to use the second RAT and perform the operations of block 504 as described.

In block 544, the processor may determine that a condition warrants attempting a wireless connection using the first RAT in response to deter mining that the data from sensors within the wireless device indicates that the wireless device has moved (i.e., block 542=“Yes”). The processor may then perform the operations of block 506 of the method 500 (FIG. 5A) as described.

In some embodiments, two or more evaluations of conditions that warrant attempting to establish a wireless connection using the preferred RAT may be performed in parallel or sequentially. For example, FIG. 5I illustrates an embodiment of the method 500 in which the determinations in blocks 508, 518, 528 and 542 as described are performed in parallel or in series in each execution of the operations in block 502. With reference to FIGS. 1-5I, as described, the operations in 502 may be performed in response to the wireless device using a non-preferred RAT and after expiration of each first duration in block 504.

In block 508, the processor may determine whether an identifier of a wireless communication cell currently providing the wireless connection using the second RAT differs from an identifier of the wireless communication cell providing the connection using the second RAT at a previous time as described with reference to FIGS. 5B and 5C.

In block 518, the processor may determine whether there has been an increase in signal strength of received wireless communication signals as described with reference to FIGS. 5D and 5E.

In block 528, the processor may determine whether the maximum coupling loss (“MCL” in the figure) for a wireless connection using the first RAT is achievable as described with reference to FIGS. 5F and 5G.

In block 542, the processor may determine from data from sensors within the wireless device whether the wireless device has moved as described with reference to FIG. 5H.

In response to all of the determinations in blocks 508, 518, 528 and 542 being “No”, the processor may continue to communicated using the second RAT for another first duration in block 504 before repeating the determinations in block 502.

In response to any of the determinations in blocks 508, 518, 528 and 542 being “Yes”, the processor may initiate or permit a determination of whether a connection can be made to a service using the first (i.e., preferred) RAT in block 506.

The method 500 may be implemented as part of or within existing methods for ensuring that the wireless device periodically checks the availability of service using the preferred RAT (e.g., Cat. M). An example of such an implementation of the method 500 is illustrated in FIG. 5J in accordance with one or more embodiments.

With reference to FIGS. 1A-5J, in block 554, the processor may determine whether the wireless device is communicating using the first RAT.

In block 556, the processor may perform a scan for signals from a wireless communication cell using the first RAT. This scan may be performed according to IoT protocols including in Cat. M, such as by sequentially tuning to and monitoring for signals on frequencies used by eNB's providing Cat. M wireless service. If signals are detected, a processor (e.g., a modem processor) may determine whether the received signals meet minimum strength and signal quality requirements to establish a wireless connection with the eNB using the preferred (i.e., first) RAT. In response to determining that received signals meet minimum strength and quality requirements, the processor completes the procedure for establishing a link to and camping on the eNB using the preferred RAT.

In response to determining that no signals using the preferred (i.e., first) RAT are received meeting minimum strength and quality requirements, the processor may establish a wireless connection with the eNB using the less-preferred (i.e., second) RAT, determine that the wireless device is not using the preferred (first) RAT, and start a second timer in block 558. This second timer may be for a duration specified in the IoT protocols (e.g., Cat. M), which generally will be for a short period of time compared to the first duration that the processor may continue to communicate using the second RAT in block 504 of the method 500. The second timer is for a relatively short duration, such as on the order of a few seconds to a few minutes, to ensure IoT devices frequently search for service on the preferred RAT, while the first duration is for a much longer period of time, such as on the order of several minutes to hours, to minimize IoT devices conducting scans for the preferred RAT while there is a low likelihood of success.

The first duration and the second timer/duration used in various embodiments may be preset or adjusted by manufacturers and service providers, and may depend upon the type of application for which the IoT device is designed. For example, for an IoT device designed for a stationary application, such as a sensor to be fixed to a particular device or in a set location, a smart meter or a smart appliance, the relatively short second timer duration may be on the order eight to twelve minutes (e.g., 10 minutes), while the first duration may be on the order of four to eight hours (e.g., 6 hours). As another example, for an IoT device designed for an application that has low mobility, such as a sensor for use on construction equipment (e.g., on a sky crane), factory equipment, or other objects that may be moved from time to time, the relatively short second timer duration may be on the order twenty to forty seconds (e.g., 30 seconds), while the first duration may be on the order of eight to twelve minutes (e.g., 10 minutes). As further example, for an IoT device designed for a mobile application, such as a sensor for use on a vehicle or trailer, or on equipment that will be moved frequently, the relatively short second timer duration may be on the order eight to twelve seconds (e.g., 10 seconds), while the first duration may be on the order of one to three minutes (e.g., 2 minutes). These examples of the two different durations that may be used in various applications are for the purpose of illustration and are not intended to be limiting unless specifically recited in a claim.

In block 502, the processor may determine whether there is a condition that warrants attempting a connection with the first (i.e., preferred) RAT as described.

In response to determining that there is no condition that warrants attempting a connection with the first RAT (i.e., block 502=“No”), the processor may continue to communicate using the second (i.e., non-preferred RAT, such as NB-IoT) for the first timer duration in block 504 as described.

In response to determining that there is a condition that warrants attempting a connection with the first RAT (i.e., block 502=“Yes”), the processor may initiate or permit performing a scan for signals from a wireless communication cell using the first RAT in block 556. Thus, the operations in block 506 of the method 500 as described may include the operations in block 556.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a wireless device and the wireless device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

A number of different cellular and mobile communication services and standards are available or contemplated in the future, all of which may implement and benefit from the various embodiments. Such services and standards include, e.g., Third Generation Partnership Project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the method 500 may be substituted for or combined with one or more operations of the method.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of conserving power in a wireless device capable of communicating via a first radio access technology (RAT) and second RAT in which communication using the first RAT is preferred, comprising:
determining whether a condition warrants attempting a connection with the first RAT in response to the wireless device communicating using the second RAT;
in response to determining that no condition warrants attempting a wireless connection using the first RAT, continuing to communicate using the second RAT for a first duration before again determining whether a condition warrants attempting a connection with the first RAT; and
determining whether a connection can be made to the first RAT in response to determining that a condition warrants attempting a wireless connection using the first RAT.

2. The method of claim 1, wherein determining whether a condition warrants attempting a wireless connection using the first RAT comprises:
determining whether an identifier of a wireless communication cell currently providing the wireless connection using the second RAT differs from an identifier of a wireless communication cell providing the connection using the second RAT at a previous time; and
determining that a condition warrants attempting a wireless connection using the first RAT in response to determining that the identifier of the wireless communication cell currently providing the wireless connection using the second RAT differs from the identifier of the wireless communication cell providing the connection using the second RAT at the previous time.

3. The method of claim 2, wherein determining whether an identifier of a wireless communication cell currently providing the wireless connection using the second RAT differs from an identifier of a wireless communication cell providing the connection using the second RAT at a previous time comprises:
storing in memory the identifier of the wireless communication cell providing the wireless connection using the second RAT;
determining an identifier of the wireless communication cell providing the wireless connection using the second RAT as part of a discontinuous reception (DRX) wake up procedure; and
determining whether the identifier of the wireless communication cell determined as part of the DRX wake up procedure differs from the stored identifier of the wireless communication cell.

4. The method of claim 1, wherein determining whether a condition warrants attempting a wireless connection using the first RAT comprises:
determining whether there has been an increase in signal strength of received wireless communication signals; and
determining that a condition warrants attempting a wireless connection using the first RAT in response to determining there has been an increase in signal strength of received wireless communication signals.

5. The method of claim 4, wherein determining whether there has been an increase in signal strength of received wireless communication signals comprises:
storing in memory the signal strength of received wireless communication signals;
determining the signal strength of received wireless communication signals as part of an enhanced discontinuous reception (eDRX) wake up procedure; and
determining whether the signal strength of received wireless communication signals determined as part of the eDRX wake up procedure exceeds the stored signal strength of received wireless communication signals by a threshold amount.

6. The method of claim 1, wherein determining whether a condition warrants attempting a wireless connection using the first RAT comprises:
determining whether a maximum coupling loss for a wireless connection using the first RAT is achievable; and
determining that a condition warrants attempting a wireless connection using the first RAT in response to determining that the maximum coupling loss for a wireless connection using the first RAT is achievable.

7. The method of claim 6, wherein determining whether the maximum coupling loss for a wireless connection using the first RAT is achievable comprises:
determining a coupling loss for the second RAT;
determining a transmit power of cell specific reference signals (CRS) and a transmit power of a narrowband reference signals (NRS) from information included in System Information Block 2 (SIB2) signals;
estimating a coupling loss for the first RAT based on the determined coupling loss of the second RAT and a ratio of the NRS transmit power to the CRS transmit power;
determining whether the estimated coupling loss for the first RAT satisfies a maximum coupling loss threshold for the first RAT; and
determining a priority list of cells for the first RAT in response to determining that the estimated coupling loss for the first RAT satisfies the maximum coupling loss threshold for the first RAT.

8. The method of claim 1, wherein determining whether a condition warrants attempting a wireless connection using the first RAT comprises:
determining whether data from sensors within the wireless device indicates that the wireless device has moved; and
determining that a condition warrants attempting a wireless connection using the first RAT in response to determining that the data from sensors within the wireless device indicates that the wireless device has moved.

9. The method of claim 1, wherein determining whether a condition warrants attempting a wireless connection using the first RAT comprises one or more of:
determining that an identifier of a wireless communication cell currently providing the wireless connection using the second RAT differs from an identifier of the wireless communication cell providing the connection using the second RAT at a previous time;
determining there has been an increase in signal strength of received wireless communication signals;
determining that a maximum coupling loss for a wireless connection using the first RAT is achievable; or
determining from data from sensors within the wireless device that the wireless device has moved.

10. The method of claim 1, further comprising:
determining whether the wireless device is communicating using the first RAT;
performing a scan for signals from a wireless communication cell using the first RAT; and
starting a second timer in response to not receiving signals from a wireless communication cell using the first RAT, the second timer being shorter than the first timer,
wherein determining whether a condition warrants attempting a connection with the first RAT in response to the multi-mode wireless device communicating using the second RAT is performed in response to expiration of the second timer.

11. The method of claim 10, wherein determining whether a connection can be made to the first preferred RAT comprises starting the second timer again in response to determining that a condition warrants attempting a wireless connection using the first RAT.

12. A wireless device, comprising:
a wireless modem capable of communicating via a first radio access technology (RAT) and second RAT in which communication using the first RAT is preferred; and
a processor coupled to the wireless modem and configured with processor-executable instructions to perform operations comprising:
determining whether a condition warrants attempting a connection with the first RAT in response to the wireless device communicating using the second RAT;
in response to determining that no condition warrants attempting a wireless connection using the first RAT, continuing to communicate using the second RAT for a first duration before again determining whether a condition warrants attempting a connection with the first RAT; and
determining whether a connection can be made to the first RAT in response to determining that a condition warrants attempting a wireless connection using the first RAT.

13. The wireless device of claim 12, wherein the processor is further configured with processor-executable instructions to perform operations such that determining whether a condition warrants attempting a wireless connection using the first RAT comprises:
determining whether an identifier of a wireless communication cell currently providing the wireless connection using the second RAT differs from an identifier of a wireless communication cell providing the connection using the second RAT at a previous time; and
determining that a condition warrants attempting a wireless connection using the first RAT in response to determining that the identifier of the wireless communication cell currently providing the wireless connection using the second RAT differs from the identifier of the wireless communication cell providing the connection using the second RAT at the previous time.

14. The wireless device of claim 13, wherein the processor is further configured with processor-executable instructions to perform operations such that determining whether an identifier of a wireless communication cell currently providing the wireless connection using the second RAT differs from an identifier of a wireless communication cell providing the connection using the second RAT at a previous time comprises:
storing in memory the identifier of the wireless communication cell providing the wireless connection using the second RAT;
determining an identifier of the wireless communication cell providing the wireless connection using the second RAT as part of a discontinuous reception (DRX) wake up procedure; and
determining whether the identifier of the wireless communication cell determined as part of the DRX wake up procedure differs from the stored identifier of the wireless communication cell.

15. The wireless device of claim 12, wherein the processor is further configured with processor-executable instructions to perform operations such that determining whether a condition warrants attempting a wireless connection using the first RAT comprises:
determining whether there has been an increase in signal strength of received wireless communication signals; and
determining that a condition warrants attempting a wireless connection using the first RAT in response to determining there has been an increase in signal strength of received wireless communication signals.

16. The wireless device of claim 15, wherein the processor is further configured with processor-executable instructions to perform operations such that determining whether there has been an increase in signal strength of received wireless communication signals comprises:
storing in memory the signal strength of received wireless communication signals;
determining the signal strength of received wireless communication signals as part of an enhanced discontinuous reception (eDRX) wake up procedure; and
determining whether the signal strength of received wireless communication signals determined as part of the eDRX wake up procedure exceeds the stored signal strength of received wireless communication signals by a threshold amount.

17. The wireless device of claim 12, wherein the processor is further configured with processor-executable instructions to perform operations such that determining whether a condition warrants attempting a wireless connection using the first RAT comprises:
determining whether a maximum coupling loss for a wireless connection using the first RAT is achievable; and
determining that a condition warrants attempting a wireless connection using the first RAT in response to determining that the maximum coupling loss for a wireless connection using the first RAT is achievable.

18. The wireless device of claim 17, wherein the processor is further configured with processor-executable instructions to perform operations such that determining whether the maximum coupling loss for a wireless connection using the first RAT is achievable comprises:
determining a coupling loss for the second RAT;
determining a transmit power of cell specific reference signals (CRS) and a transmit power of a narrowband reference signals (NRS) from information included in System Information Block 2 (SIB2) signals;
estimating a coupling loss for the first RAT based on the determined coupling loss of the second RAT and a ratio of the NRS transmit power to the CRS transmit power;
determining whether the estimated coupling loss for the first RAT satisfies a maximum coupling loss threshold for the first RAT; and
determining a priority list of cells for the first RAT in response to determining that the estimated coupling loss for the first RAT satisfies the maximum coupling loss threshold for the first RAT.

19. The wireless device of claim 12, wherein the processor is further configured with processor-executable instructions to perform operations such that determining whether a condition warrants attempting a wireless connection using the first RAT comprises:
determining whether data from sensors within the wireless device indicates that the wireless device has moved; and
determining that a condition warrants attempting a wireless connection using the first RAT in response to determining that the data from sensors within the wireless device indicates that the wireless device has moved.

20. The wireless device of claim 12, wherein the processor is further configured with processor-executable instructions to perform operations such that determining whether a condition warrants attempting a wireless connection using the first RAT comprises one or more of:
determining that an identifier of a wireless communication cell currently providing the wireless connection using the second RAT differs from an identifier of the wireless communication cell providing the connection using the second RAT at a previous time;
determining there has been an increase in signal strength of received wireless communication signals;
determining that the maximum coupling loss for a wireless connection using the first RAT is achievable; or
determining from data from sensors within the wireless device that the wireless device has moved.

21. The wireless device of claim 12, wherein the processor is further configured with processor-executable instructions to perform operations further comprising:
determining whether the wireless device is communicating using the first RAT;
performing a scan for signals from a wireless communication cell using the first RAT; and
starting a second timer in response to not receiving signals from a wireless communication cell using the first RAT, the second timer being shorter than the first timer,
wherein determining whether a condition warrants attempting a connection with the first RAT in response to the multi-mode wireless device communicating using the second RAT is performed in response to expiration of the second timer.

22. The wireless device of claim 21, wherein the processor is further configured with processor-executable instructions to perform operations such that determining whether a connection can be made to the first preferred RAT comprises starting the second timer again in response to determining that a condition warrants attempting a wireless connection using the first RAT.

23. A non-transitory processor-readable medium having stored thereon processor-executable instructions configured to cause a processor of a wireless device capable of communicating via a first radio access technology (RAT) and second RAT, in which communication using the first RAT is preferred, to perform operations comprising:
determining whether a condition warrants attempting a connection with the first RAT in response to the wireless device communicating using the second RAT;
in response to determining that no condition warrants attempting a wireless connection using the first RAT, continuing to communicate using the second RAT for a first duration before again determining whether a condition warrants attempting a connection with the first RAT; and
determining whether a connection can be made to the first RAT in response to determining that a condition warrants attempting a wireless connection using the first RAT.

24. The non-transitory processor-readable medium of claim 23, wherein the stored processor-executable instructions are configured to cause the processor of the wireless device to perform operations such that determining whether a condition warrants attempting a wireless connection using the first RAT comprises:
determining whether an identifier of a wireless communication cell currently providing the wireless connection using the second RAT differs from an identifier of a wireless communication cell providing the connection using the second RAT at a previous time; and
determining that a condition warrants attempting a wireless connection using the first RAT in response to determining that the identifier of the wireless communication cell currently providing the wireless connection using the second RAT differs from the identifier of the wireless communication cell providing the connection using the second RAT at the previous time.

25. The non-transitory processor-readable medium of claim 23, wherein the stored processor-executable instructions are configured to cause the processor of the wireless device to perform operations such that determining whether a condition warrants attempting a wireless connection using the first RAT comprises:
determining whether there has been an increase in signal strength of received wireless communication signals; and
determining that a condition warrants attempting a wireless connection using the first RAT in response to determining there has been an increase in signal strength of received wireless communication signals.

26. The non-transitory processor-readable medium of claim 23, wherein the stored processor-executable instructions are configured to cause the processor of the wireless device to perform operations such that determining whether a condition warrants attempting a wireless connection using the first RAT comprises:
determining whether a maximum coupling loss for a wireless connection using the first RAT is achievable; and
determining that a condition warrants attempting a wireless connection using the first RAT in response to determining that the maximum coupling loss for a wireless connection using the first RAT is achievable.

27. The non-transitory processor-readable medium of claim 23, wherein the stored processor-executable instructions are configured to cause the processor of the wireless device to perform operations such that determining whether a condition warrants attempting a wireless connection using the first RAT comprises:
determining whether data from sensors within the wireless device indicates that the wireless device has moved; and
determining that a condition warrants attempting a wireless connection using the first RAT in response to determining that the data from sensors within the wireless device indicates that the wireless device has moved.

28. The non-transitory processor-readable medium of claim 23, wherein the stored processor-executable instructions are configured to cause the processor of the wireless device to perform operations such that determining whether a condition warrants attempting a wireless connection using the first RAT comprises one or more of:
determining that an identifier of a wireless communication cell currently providing the wireless connection using the second RAT differs from an identifier of the wireless communication cell providing the connection using the second RAT at a previous time;
determining there has been an increase in signal strength of received wireless communication signals;
determining that a maximum coupling loss for a wireless connection using the first RAT is achievable; or
determining from data from sensors within the wireless device that the wireless device has moved.

29. A wireless device, comprising:
means for communicating via a first radio access technology (RAT) and second RAT, in which communication using the first RAT is preferred;
means for determining whether a condition warrants attempting a connection with the first RAT in response to the wireless device communicating using the second RAT;
means for continuing to communicate using the second RAT for a first duration before again determining whether a condition warrants attempting a connection with the first RAT in response to determining that no condition warrants attempting a wireless connection using the first RAT; and
means for determining whether a connection can be made to the first RAT in response to determining that a condition warrants attempting a wireless connection using the first RAT.

30. The wireless device of claim 29, wherein means for determining whether a condition warrants attempting a wireless connection using the first RAT comprises one or more of:
means for determining that an identifier of a wireless communication cell currently providing the wireless connection using the second RAT differs from an identifier of the wireless communication cell providing the connection using the second RAT at a previous time;
means for determining there has been an increase in signal strength of received wireless communication signals;
means for determining that a maximum coupling loss for a wireless connection using the first RAT is achievable; or
means for determining from data from sensors within the wireless device that the wireless device has moved.
